(19) United States
(12) Patent Application Publication
(10) Pub. No.: US 2010/0265435 A1
(43) Pub. Date: Oct. 21, 2010

(54) DISPLAY APPARATUS HAVING VARIABLE DIFFUSER FILM

(76) Inventors: Seong-Yong HWANG, Asan-si (KR); Jin Seo, Osan-si (KR); Insun Hwang, Suwon-si (KR); Seul-Gi Kim, Seoul (KR); SeungChul Jeong, Seoul (KR)

Correspondence Address: Innovation Counsel LLP, 21771 Stevens Creek Blvd, Ste. 200A, Cupertino, CA, 95014, US

(21) Appl. No.: 12/764,832

(22) Filed: Apr. 21, 2010

(30) Foreign Application Priority Data
Apr. 21, 2009 (KR) 10-2009-0034816

(51) Int. Cl. G02F 1/1335

(52) U.S. Cl. 349/64

(57) ABSTRACT

In a display apparatus according to an embodiment, a variable diffuser film is disposed between a backlight unit generating light and a display panel displaying an image. The variable diffuser film transmits or scatters the light from the backlight unit in response to an electrical signal to control a viewing angle. The variable diffuser film is disposed between the first and second transparent layers and includes a polymer layer in which liquid crystal molecules transmitting or scattering the light according to the electrical signal are dispersed. The polymer layer has a thickness of about 3 micrometers to about 15 micrometers, and the liquid crystal molecules have an anisotropic refractive index (Δn) of about 0.15 to about 0.25. In one aspect, the display apparatus may automatically switch a narrow viewing angle mode and a wide viewing angle mode, thereby reducing power consumption necessary to switch the narrow and wide viewing angle modes.

### CROSS-REFERENCE TO RELATED APPLICATIONS

This application claims priority to and benefit of Korean Patent Application No. 10-2009-34816, filed Apr. 21, 2009, the contents of which are herein incorporated by reference in their entirety.

### BACKGROUND

1. Technical Field

The present invention relates to a display apparatus and, more particularly, to a display apparatus capable of controlling a wide viewing angle and a narrow viewing angle.

2. Related Art

In general, wide viewing angle technology has been developed so that a user may watch displayed images on a liquid crystal display (LCD) at various angles. The LCD to which the wide viewing angle technology is applied vividly displays images with a wide viewing angle, so as to not be distorted.

However, in order to meet the various demands of the consumers, such as protection of privacy, recently, a narrow viewing angle technology is required.

According to the narrow viewing angle technology, only users who are positioned at the front of the screen can watch the images, so that the narrow viewing angle technology is useful to operate documents in secret.

The LCD to which the narrow viewing angle mode is applied includes a viewing angle control film (VACF) in order to reduce the viewing angle. When the viewing angle control film is attached on the screen of the LCD, the viewing angle is limited to about 60 degrees in left and right with reference to the front of the screen. In this instance, the user positioned at the sides of the screen may only see black images, and the user positioned at the front side of the screen may see vivid images as displayed on the screen.

However, to display images in a wide viewing angle mode after displaying images in a narrow viewing angle mode by using the viewing angle control film, the viewing angle control film has to be detached from the screen of the LCD. Consequently, the switching operation between the narrow viewing angle mode and the wide viewing angle mode is not simply performed, and the viewing angle control film, which is typically only used once, may be difficult to recycle.

### SUMMARY

An exemplary embodiment of the present invention provides a display apparatus capable of automatically switching a wide viewing angle mode and a narrow viewing angle mode.

According to an exemplary embodiment of the present invention, a display apparatus includes a backlight unit that generates a light, a variable diffuser film disposed on the backlight unit to transmit or scatter the light in response to electrical signals, and a display panel that receives the light exiting from the variable diffuser film to display an image.

The variable diffuser film includes a first transparent electrode layer that receives a first driving voltage among the electrical signals, a second transparent electrode layer that receives a second driving voltage having a voltage level different from a voltage level of the first driving voltage among the electrical signals and faces the first transparent electrode layer, and a polymer layer disposed between the first and second transparent layers and including liquid crystal molecules dispersed in the polymer layer to transmit or scatter the light in response to the electrical signals.

The polymer layer may have a thickness of about 3 micrometers (μm) to about 15 micrometers (μm). The liquid crystal molecules may have an anisotropic refractive index (Δn) of about 0.15 to about 0.25.

In one embodiment, the variable diffuser film may be disposed between the backlight unit and the display panel to transmit or scatter the light in response to the electrical signals. The variable diffuser film may be disposed between the two transparent electrode layers and includes the liquid crystal molecules in which the liquid crystal molecules are dispersed. Thus, in one aspect, the variable diffuser film may be turned on or off by the driving voltage, thereby automatically switching a viewing angle mode.

In one embodiment, when the thickness of the polymer layer is about 3 micrometers to about 15 micrometers and the anisotropic refractive index (Δn) of the liquid crystal molecules is of about 0.15 to about 0.25, power consumption to switch the viewing angle mode may be reduced, and transmittance and light scattering characteristics may be prevented from deterioration.

### BRIEF DESCRIPTION OF THE DRAWINGS

The above and other advantages of embodiments of the present invention will become readily apparent by reference to the following detailed description when considered in conjunction with the accompanying drawings wherein:

FIG. 1 is a sectional view showing an exemplary embodiment of a display apparatus according to the present invention;

FIGS. 2 and 3 are enlarged views of a portion I of an electrically variable diffuser (EVD) film of FIG. 1, in accordance with an embodiment of the present invention;

FIG. 4 is a view showing a traveling path of a light in a narrow viewing angle mode, in accordance with an embodiment of the present invention;

FIG. 5 is a view showing a traveling path of a light in a wide viewing angle mode, in accordance with an embodiment of the present invention;

FIG. 6 is an enlarged view showing a viewing angle control (VAC) film of FIG. 1, in accordance with an embodiment of the present invention;

FIG. 7 is a graph showing variations of the viewing angle by the EVD film and the VAC film, in accordance with an embodiment of the present invention;

FIGS. 8A and 8B are views showing traveling directions of the light according to a type of reflection sheets, in accordance with an embodiment of the present invention;

FIG. 9 is a graph showing a viewing angle according to the reflection sheets shown in FIGS. 8A and 8B, in accordance with an embodiment of the present invention;

FIG. 10 is an exploded perspective view showing the EVD film of FIG. 1, in accordance with an embodiment of the present invention;

FIG. 11 is a cross-sectional view taken along a line I-I′ of FIG. 11, in accordance with an embodiment of the present invention;

FIGS. 12A and 12B are sectional views showing a connection structure of the EVD film and an FPC film, in accordance with an embodiment of the present invention; and

FIG. 13 is a perspective view showing a receiving container, in accordance with an embodiment of the present invention.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

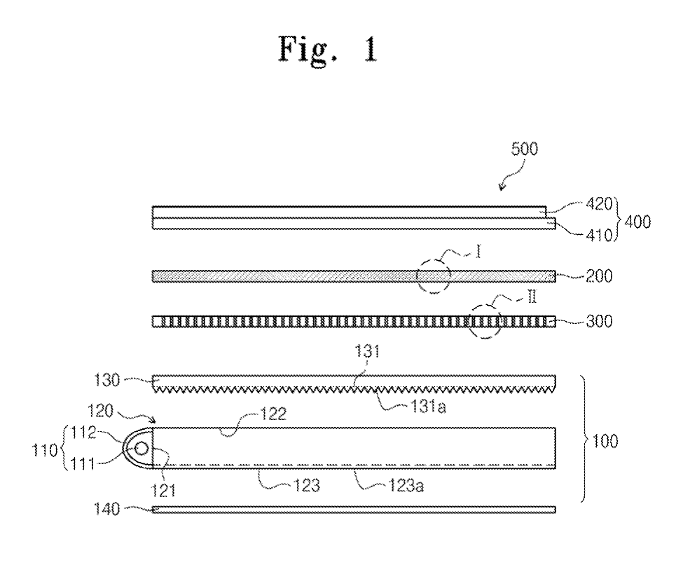

FIG. 1 is a sectional view showing an exemplary embodiment of a display apparatus according to the present invention. Referring to FIG. 1, a display apparatus 500 includes a backlight unit 100, an electrically variable diffuser (EVD) film 200, a viewing angle control (VAC) film 300, and a display panel 400.

The backlight unit 100 includes a light source unit 110, a light guide plate 120, a reverse prism sheet 130, and a reflection sheet 140. The light source unit 110 includes a light source 111 and a cover 112 that covers the light source 111 and reflects a light emitted from the light source 111 to the light guide plate 120. In an example of the present invention, the light source 111 includes a cold cathode fluorescent lamp, but the light source 111 may be a light emitting diode.

The light guide plate 120 has a rectangular plate shape, and the light source unit 110 is arranged adjacent to a side surface 121 of the light guide plate 120. The light generated by the light source unit 110 is incident into the light guide plate 120 through the side surface 121, and the incident light exits through an upper surface 122 of the light guide plate 120. Plural first prism patterns 123a are arranged on a lower surface 123 of the light guide plate 120. The first prism patterns 123a extend in a first direction and are arranged in a second direction substantially perpendicular to the first direction. Thus, in one aspect, the light incident into the light guide plate 120 is reflected from and condensed by the lower surface 123 such that the light travels toward the upper surface 122.

The reflection sheet 140 is disposed under the light guide plate 120 to reflect the light leaked from the light guide plate 120 to the light guide plate 120, thereby improving light efficiency of the backlight unit 100. In the present exemplary embodiment, the reflection sheet 140 may be a regular reflection sheet, and the regular reflection sheet 140 may include silver (Ag).

The reverse prism sheet 130 is disposed on the light guide plate 120 and includes plural second prism patterns 131a formed on a lower surface 131 of the reverse prism sheet 130, which faces the upper surface 122 of the light guide plate 120. The second prism patterns 131a extend in the second direction and are arranged in the first direction, so that the second prism patterns 131a are substantially perpendicular to the first prism patterns 123a.

In the present exemplary embodiment, a structure that the first prism patterns 123a are formed on the lower surface 123 of the light guide plate 120 and the reverse prism sheet 130 is disposed on the light guide plate 120 has been described. However, the backlight unit 100 may include a flat light guide plate (not shown) on which no prism patterns are formed. In this case, the backlight unit 100 may include two prism sheets (not shown) disposed on the flat light guide plate, on which first and second prism patterns are respectively formed.

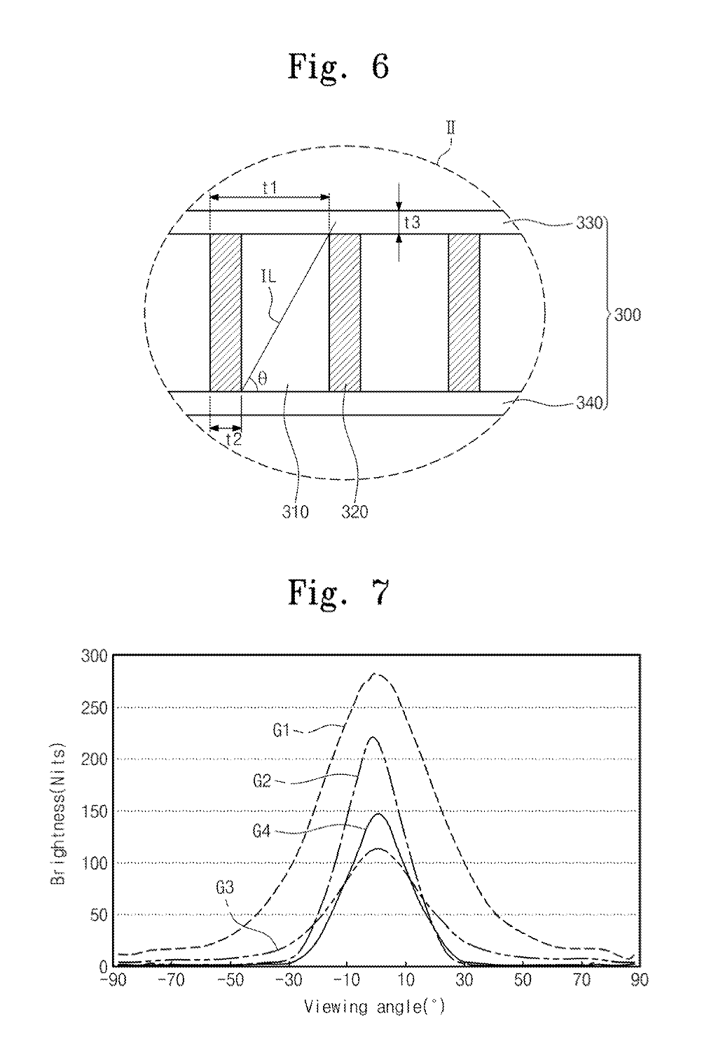

The VAC film 300 is disposed on the reverse prism sheet 130. The light exiting from the reverse prism sheet 130 passes through the VAC film 300, and the light exiting from the VAC film 300 has a viewing angle narrower than a viewing angle before the light passes through the VAC film 300. That is, among the light exiting from the reverse prism sheet 130, the VAC film 300 absorbs the light having a relatively small incident angle with respect to its incident angle and transmits the light having a relatively large incident angle with respect to the incident angle, to thereby adjust the viewing angle. The structure of the VAC film 300 will be described with reference to FIG. 6.

The EVD film 200 is disposed on the VAC film 300 and receives the light having the viewing angle adjusted by the VAC film 300. The EVD film 200 includes a polymer layer in which liquid crystal molecules are distributed, and the EVD film 200 is turned on or off in response to a driving voltage applied from an exterior thereof. When the EVD film 200 is turned on, the liquid crystal molecules are vertically aligned such that the light passes through the EVD film 200, but the liquid crystal molecules scatter the incident light when the EVD film 200 is turned off.

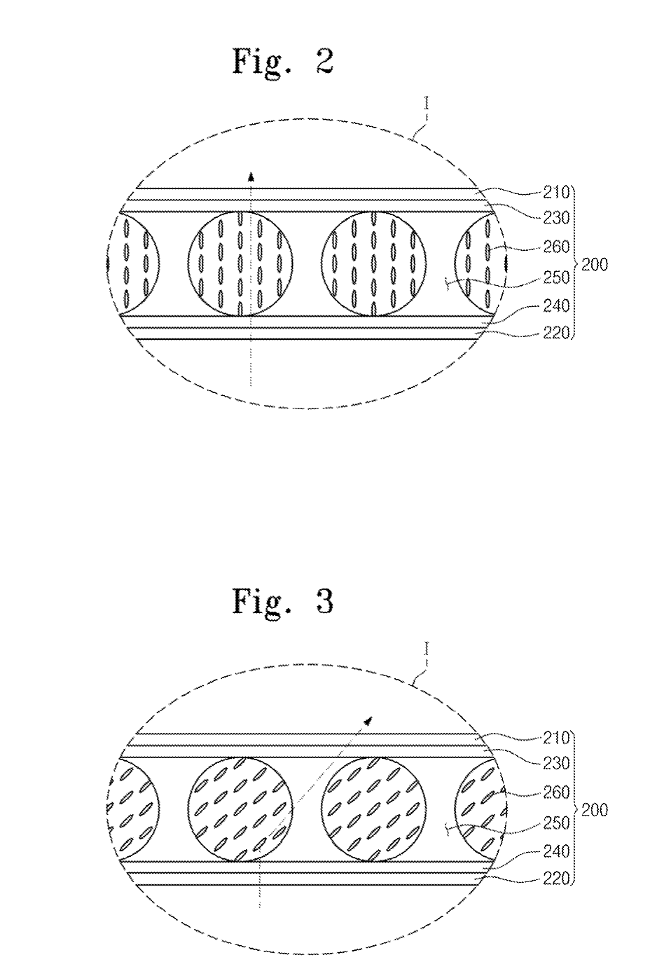

Consequently, when the EVD film 200 is turned on, the light having the viewing angle narrowed by the VAC film 300 exits from the EVD film 200, and thus, in one aspect, the display apparatus 500 is operated in a narrow viewing angle mode. On the other hand, when the EVD film 200 is turned off, the light having the viewing angle narrowed by the VAC film 300 is scattered by the liquid crystal molecules of the EVD film 200, and thus, in one aspect, the display apparatus 500 is operated in a wide viewing angle mode. Further descriptions of the EVD film 200 will be described with reference to FIGS. 2 and 3.

The display panel 400 is disposed on the EVD film 200 and includes a lower substrate 410, an upper substrate 420, and a liquid crystal layer (not shown). The lower substrate 410 and the upper substrate 420 face each other with a space therebetween, and the liquid crystal layer is disposed between the lower substrate 410 and the upper substrate 420. In an example of the present invention, the lower substrate 410 may be a thin film transistor substrate in which pixels are formed in a matrix configuration, and the upper substrate 420 may be a color filter substrate in which color filters are arranged corresponding to the pixels. However, it should be appreciated that the lower and upper substrates 410 and 420 should not be limited thereto or thereby, and the color filters may be formed on the lower substrate 410.

The display panel 400 receives the light exiting from the EVD film 200 to display images. Particularly, the display panel 400 controls the transmittance of light provided from the EVD film 200 by using the liquid crystal layer to display gray scales, thereby displaying desired images. When the EVD film 200 is turned on, the display panel 400 displays images in the narrow viewing angle mode, and when the EVD film 200 is turned off, the display panel 400 displays images in the wide viewing angle mode.

As described above, the narrow viewing angle mode and the wide viewing angle mode may be automatically switched by turning on or turning off the EVD film 200. In addition, during the narrow viewing angle mode, the image information is provided to only the user positioned at the front of the screen, and the black images in which the image information is not included is provided to the user positioned at sides of the screen, thereby protecting the user's privacy.

FIGS. 2 and 3 are enlarged views of a portion I of an electrically variable diffuser (EVD) film of FIG. 1, in accordance with an embodiment of the present invention. In particular, FIG. 2 shows the EVD film 200 in turn-on state, and FIG. 3 shows the EVD film 200 in turn-off state.

Referring to FIGS. 2 and 3, the EVD film 200 includes a first base film 210, a second base film 220, a first transparent electrode layer 230, a second transparent electrode layer 240, and a polymer layer 250. The first and second base films 210 and 220 are spaced apart from each other by a predetermined distance and arranged in substantially parallel to each other. The first transparent electrode layer 230 is formed on the first base film 210, and the second transparent electrode layer 240 is formed on the second base film 220 to face the first transparent electrode layer 230. The first and second transparent electrode layers 230 and 240 may be formed by a coating method on the first and second base films 210 and 220, respectively.

In the present exemplary embodiment, the first and second transparent electrode layers 230 and 240 may include a transparent conductive material, such as indium-tin-oxide (ITO). In one aspect, the first and second transparent electrode layers 230 and 240 may include a transparent conductive polymer material, without departing from the scope of an embodiment of the present invention.

The first transparent electrode layer 230 receives a first driving voltage from an exterior thereof, and the second transparent electrode layer 240 receives a second driving voltage from an exterior thereof. When an electric field is formed between the first and second transparent electrode layers 230 and 240 by a potential difference between the first and second driving voltages (which, hereinafter, may be referred to as a driving voltage of the EVD film 200), the EVD film 200 is turned on, and when the driving voltage is applied to the EVD film 200, the EVD film 200 is turned off.

The polymer layer 250 is interposed between the first and second transparent electrode layers 230 and 240 and includes liquid crystal molecules 260 distributed therein. The liquid crystal molecules 260 distributed in the polymer layer 250 transmit or reflect the incident light in response to the driving voltage of the EVD film 200. In an example of the present invention, the liquid crystal molecules 260 are positive type liquid crystal molecules each of which has a larger dielectric constant in its long axis than a dielectric constant in its short axis. The polymer layer 250 has a refractive index equal to an ordinary refractive index (no) or an extra-ordinary refractive index (ne) of the liquid crystal molecules 260.

The polymer layer 250 in which the liquid crystal molecules 260 are distributed may be formed by the following methods. According to a method, liquid crystal molecules and polymer are mixed with each other by using a solvent, and then the solvent is removed from the mixed solution, thereby forming the polymer layer 250 in which the liquid crystal molecules 260 are distributed. In another method, liquid crystal molecules are mixed with polymer (or monomer) in a liquid phase, and then an ultraviolet ray is irradiated to the mixed solution to cure the polymer (or monomer), thereby forming the polymer layer 250 in which the liquid crystal molecules 260 are distributed. The method of forming the polymer layer 250 in which the liquid crystal molecules 260 are distributed should not be limited thereto or thereby.

As shown in FIG. 2, when the driving voltage is applied to the EVD film 200, the liquid crystal molecules 260 are vertically aligned to transmit the incident light. However, as shown in FIG. 3, when the EVD film 200 is turned off, the liquid crystal molecules 260 scatter the light.

In one aspect, to improve the operation characteristics of the EVD film 200, a driving voltage at a high voltage level may be required. However, when the voltage level of the driving voltage becomes high, the power consumption of the display apparatus 500 increases. Accordingly, a thickness of the polymer layer 250 may be reduced to a range of about 3 micrometers to about 15 micrometers to decrease the voltage level of the driving voltage. That is, when the distance between the first transparent electrode layer 230 and the second transparent electrode layer 240 decreases, the operation characteristics of the EVD film 200 may be improved without increasing the voltage level of the EVD film 200.

However, when the thickness of the polymer layer 250 becomes thin, an amount of the liquid crystal molecules 260 in the EVD film 200 decreases. Thus, during the turn-off state of the EVD film 200, light scattering characteristics of the incident light to the EVD film 200 is deteriorated. As a result, the viewing angle of the display apparatus 500 may be reduced when the display apparatus 500 is operated in the wide viewing angle mode.

In one aspect, to compensate the deteriorated light scattering characteristics of the incident light due to the thickness reduction of the polymer layer 250, the polymer layer 250 may include the liquid crystal molecules 260 having an anisotropic refractive index (Δn) of about 0.15 to about 0.25. For example, the light scattering characteristics of the liquid crystal molecules 260 increases as the anisotropic refractive index (Δn) of the liquid crystal molecules 260 increases. Thus, when the anisotropic refractive index (Δn) of the liquid crystal molecules 260 is set to the range of about 0.15 to about 0.25, the viewing angle of the display apparatus 500 may be prevented from being reduced in a wide viewing angle mode although the thickness of the polymer layer 250 decreases.

In addition, as an anisotropic dielectric constant (Δε) of the liquid crystal molecules 260 becomes large, the operation characteristics of the EVD film 200 may be improved under a relatively low driving voltage. Accordingly, in an example of the present invention, the liquid crystal molecules 260 may have the anisotropic dielectric constant (Δε) of about 10 to about 30.

In one aspect, transmittance (%) and a full-width-half-maximum (FWHM) of the EVD film 200 may depend on a concentration of the liquid crystal molecules in the EVD film 200. Table 1 shows the transmittance and the FWHM of the EVD film 200 measured while varying the thickness (μm) of the polymer layer 250 and the concentration (wt %) of the liquid crystal molecules 260 under the condition that the liquid crystal molecules 260 has the anisotropic refractive index (Δn) of about 0.217 and the anisotropic dielectric constant (Δε) of about 14.1.

TABLE 1

| Thickness (μm) | 5 | | | | 10 | | | |
|---|---|---|---|---|---|---|---|---|
| Concentration (wt %) | 60 | 70 | 76 | 80 | 60 | 70 | 76 | 80 |
| Transmittance (%) | 70 | 48 | 29 | 21 | 54 | 25 | 17 | 15 |
| FWHM | 24 | 30 | 33.5 | 41.5 | 26 | 35 | 55 | 60 |

In one aspect, as shown in Table 1, in the instance that the thickness of the polymer layer 250 is set to 5 micrometers and 10 micrometers, as the concentration (wt %) of the liquid crystal molecules 260 increases, the transmittance (%) decreases and the FWHM increases. However, when the thickness of the polymer layer 250 increases from 5 micrometers to 10 micrometers on the assumption of the same concentration (wt %), the transmittance (%) decreases and the FWHM increases. In Table 1, the transmittance (%) and the FWHM indicate the transmittance and the FWHM of the light passing through the EVD film 200 in the turn-off state.

In one aspect, it is preferable that the transmittance is low when the EVD film 200 is in the turn-off state, so that it is preferable that the concentration of the liquid crystal molecules increases. However, if the concentration of the liquid crystal molecules excessively increases, an adhesive force between the polymer layer 250 and the first and second transparent electrode layers 230 and 240 becomes weak. Therefore, the concentration of the liquid crystal molecules may be set to a range of about 65% to about 85%, and preferably, the concentration of the liquid crystal molecules may be set to about 70% in consideration of the transmittance, the FWHM, and the adhesive force.

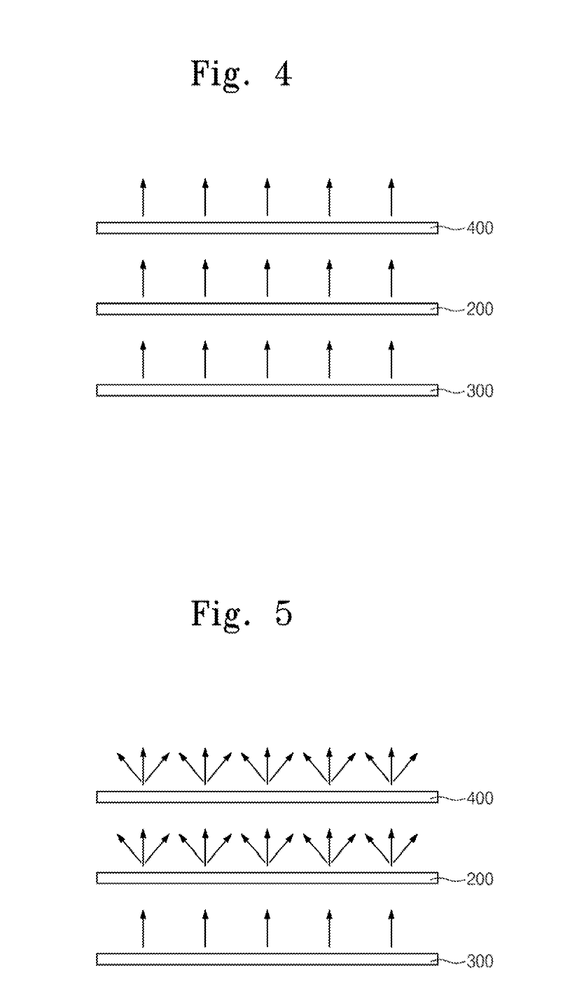

FIG. 4 is a view showing a traveling path of a light in a narrow viewing angle mode, in accordance with an embodiment of the present invention. FIG. 5 is a view showing a traveling path of a light in a wide viewing angle mode, in accordance with an embodiment of the present invention.

Referring to FIGS. 4 and 5, the VAC film 300, the EVD film 200, and the display panel 400 are sequentially stacked from the bottom to the top. To simplify the explanation, the backlight unit 100 disposed under the VAC film 300 will be omitted in FIGS. 4 and 5.

As shown in FIG. 4, the light having the viewing angle narrowed by the VAC film 300 is incident into the EVD film 200. When the EVD film 200 is in turn-on state, the liquid crystal molecules 260 are vertically aligned by the driving voltage, so that the incident light passes through the liquid crystal molecules 260. Accordingly, the display panel 400 displays images in the narrow viewing angle mode.

However, as shown in FIG. 5, when the EVD film 200 is in turn-off state, the liquid crystal molecules 260 scatter the incident light thereinto. Thus, the viewing angle of the incident light becomes wide by the EVD film 200 that is in the turn-off state, so that the display panel 400 displays images in the wide viewing angle mode.

FIG. 6 is an enlarged view showing a viewing angle control (VAC) film of FIG. 1, in accordance with an embodiment of the present invention. Referring to FIG. 6, the VAC film 300 includes a plurality of transparent layers 310 that transmits the light from the backlight unit 100 shown in FIG. 1 and a plurality of absorbing layers 320 that absorbs the light from the backlight unit 100. The transparent layers 310 are alternately arranged with the absorbing layers 320 along a direction parallel to a horizontal surface of the EVD film 200 shown in FIG. 1.

In one aspect, to reduce the viewing angle of the light exiting from the VAC film 300 to below 30 degrees, an angle (θ) between a lower surface of each transparent layer 310 and an imaginary line (IL) connecting a left lower corner and a right upper corner in each transparent layer 310 is set to a range of about 60 degrees to about 80 degrees. In reference to the above, when the angle (θ) is set to a range of about 60 degrees to about 80 degrees, the light incident at an angle smaller than 60 degrees is absorbed by the absorbing layers 320, so as to not pass the VAC film 300. Accordingly, the viewing angle of the light passing through the VAC film 300 may be smaller than 30 degrees.

In the present exemplary embodiment, a sum of thickness (t1) of the absorbing layers 320 and the transparent layers 310 is of about 30 micrometers to about 80 micrometers to prevent moiré from occurring between the VAC film 300 and the pixels arranged on the display panel 400 shown in FIG. 1. In addition, each absorbing layer 320 includes a carbon material. The VAC film 300 has a transmittance and a black brightness depending on a concentration of the carbon material and a thickness (t2) of each absorbing layer 320. The black brightness may be defined by a brightness of the VAC film 300 when the VAC film 300 is viewed at a side thereof.

TABLE 2

| Carbon | | | |
|---|---|---|---|
| concentration | Thickness (t2) | | Black brightness |
| (wt %) | (μm) | Transmittance (%) | (nits) |
| 12 | 5 | 74.5 | 17 |
| 12 | 11 | 72.6 | 15 |
| 18 | 5 | 72.8 | 21 |
| 18 | 11 | 71.4 | 21 |

As shown in Table 2, as the carbon concentration increases, the transmittance decreases and the black brightness increases. Also, in case that the carbon concentration is 18 wt %, the black brightness is highly represented at 21 nits without relating to the thickness (t2) of each absorbing layer 320. That is, when the black brightness increases, the viewing angle may not be narrow enough. Therefore, it is preferable that the carbon concentration is set to below 18 wt % to prevent the increase of the black brightness. In the present exemplary embodiment, the carbon concentration may be set to a range of about 3 wt % to about 12 wt %.

Referring to Table 2, when the thickness (t2) of each absorbing layer 320 increases, the transmittance decreases. Accordingly, to prevent the transmittance from being reduced below 70%, it is preferable that each absorbing layer 320 has a thickness equal to or smaller than about 12 micrometers. In the present exemplary embodiment, the thickness of each absorbing layer 320 may be set to a range of about 5 micrometers to about 12 micrometers.

As shown in FIG. 6, the VAC film 300 may include a first protection layer 330 and a second protection layer 340. The first protection layer 330 covers the upper surfaces of the transparent layers 310, and the second protection layer 340 covers the lower surfaces of the absorbing layers 320. In an example of the present invention, each of the first and second protection layers 330 and 340 may have a thickness (t3) of about 10 micrometers to about 50 micrometers.

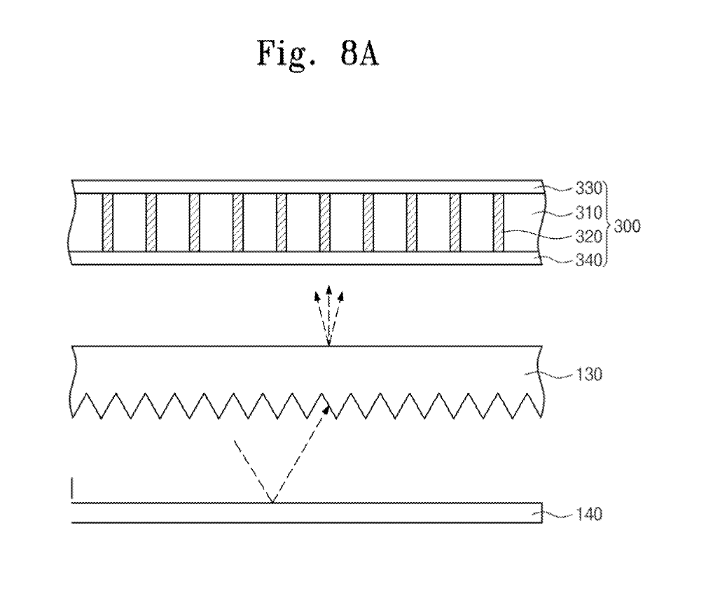

FIG. 7 is a graph showing variations of the viewing angle by the EVD film and the VAC film. In FIG. 7, a first graph G1 represents a brightness distribution according to a viewing angle of a light (which, hereinafter, may be referred to as a first light) emitted from the backlight unit 100, a second graph G2 represents a brightness distribution according to a viewing angle of a light (which, hereinafter, may be referred to as a second light) sequentially passing through the backlight unit 100 and the VAC film 300, a third graph G3 represents a brightness distribution according to a viewing angle of a light (which, hereinafter, may be referred to as a third light) sequentially passing through the backlight unit 100, the VAC film 300, and the EVD film 200 in the turn-off state, and a fourth graph G4 represents a brightness distribution according to a viewing angle of a light (which, hereinafter, may be referred to as a fourth light) sequentially passing through the backlight unit 100, the VAC film 300, and the EVD film 200 in the turn-on state.

Referring to FIG. 7, the second light passing through the backlight unit 100 and the VAC film 300 has brightness lower than that of the first light emitted from the backlight unit 100 and a viewing angle narrower than that of the first light.

In addition, the fourth light passing through the backlight unit 100, the VAC film 300, and the EVD film 200 in the turn-on state has brightness lower than that of the second light, but the fourth light has a brightness distribution similar to that of the second light. On the other hand, the third light passing through the backlight unit 100, the VAC film 300, and the EVD film 200 in the turn-off state is scattered by the liquid crystal molecules, so that the third light has a brightness distribution that is more gently sloping than that of the fourth light. Thus, in one aspect, the liquid crystal display (LCD) 500 uses the third light while operated in the wide viewing angle mode and uses the fourth light while operated in the narrow viewing angle mode.

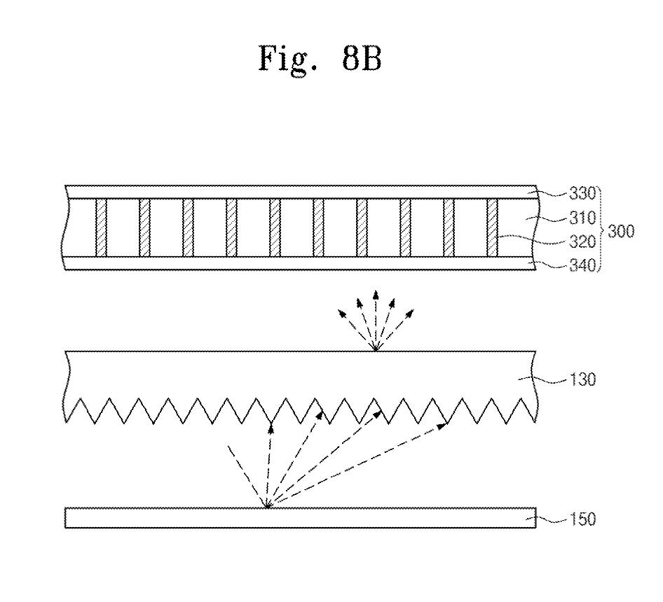

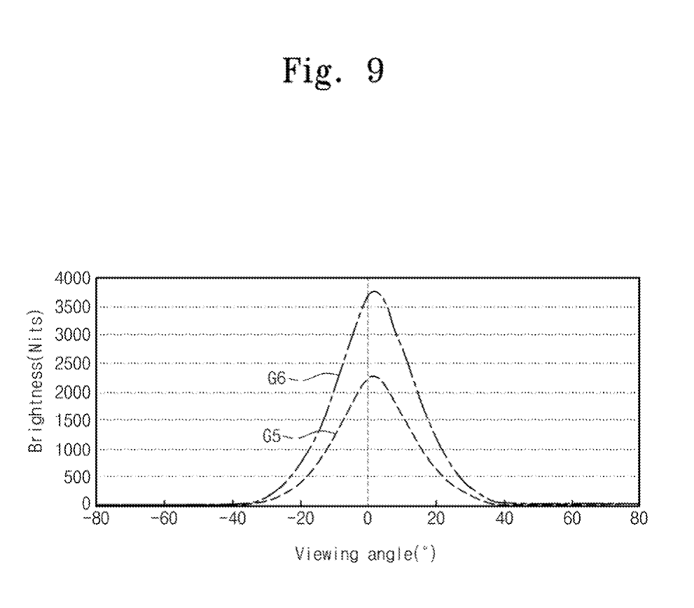

FIGS. 8A and 8B are views showing traveling directions of the light according to a kind of reflection sheets, in accordance with an embodiment of the present invention. FIG. 9 is a graph showing a viewing angle according to the reflection sheets shown in FIGS. 8A and 8B, in accordance with an embodiment of the present invention.

In FIGS. 8A and 8B, a structure that the reflection sheet, the reverse prism sheet, and the VAC film are sequentially stacked from the bottom to the top. Although not shown in FIGS. 8A and 8B, the light guide plate is disposed between the reflection and the reverse prism sheet. However, to simplify the explanation, the light guide plate has been omitted from FIGS. 8A and 8B.

Referring to FIG. 8A, the reflection sheet 140 may be the regular reflection sheet that regularly reflects the incident light. The reverse prism sheet 130 condenses the regularly-reflected light by the regular reflection sheet, so that the viewing angle of the light exiting from the reverse prism sheet 130 becomes narrow. Accordingly, in one aspect, the light exiting from the reverse prism sheet 130 may pass through the transparent layers 310 of the VAC film 300, thereby relatively reducing light loss while the light passes through the VAC film 300.

However, as shown in FIG. 8B, in the instance that the reflection sheet 140 is replaced with an irregular reflection sheet 150 that irregularly reflects the incident light, the viewing angle of the light exiting from the reverse prism sheet 130 becomes wide. Thus, the amount of the light, which is absorbed by the absorbing layers, of the light exiting from the reverse prism sheet 130 increases, to thereby relatively increasing the light loss while the light passes through the VAC film 300.

In FIG. 9, a fifth graph G5 represents a brightness distribution of a light passing through the EVD film 200 in the turn-on state when the regular reflection sheet (e.g., ESR sheet manufactured by 3M) is adopted, and a sixth graph G6 represents a brightness distribution of a light passing through the EVD film 200 in the turn-on state when the irregular reflection sheet (e.g., white reflector) is adopted.

As shown in FIG. 9, the brightness of light passing through the EVD film 200 when the regular reflection sheet 140 is utilized is higher than the brightness of light passing through the EVD film 200 when the irregular reflection sheet 140 is utilized. That is, when the regular reflection sheet 140 is applied to the LCD 500, the whole brightness of the LCD 500 may be enhanced.

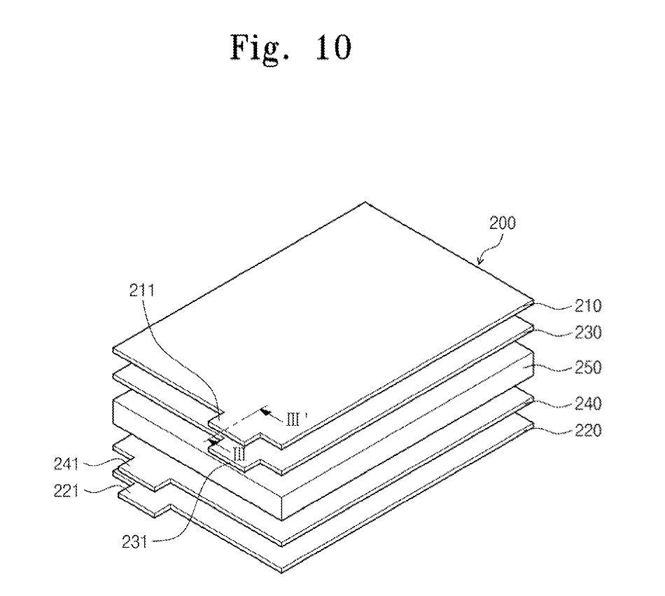

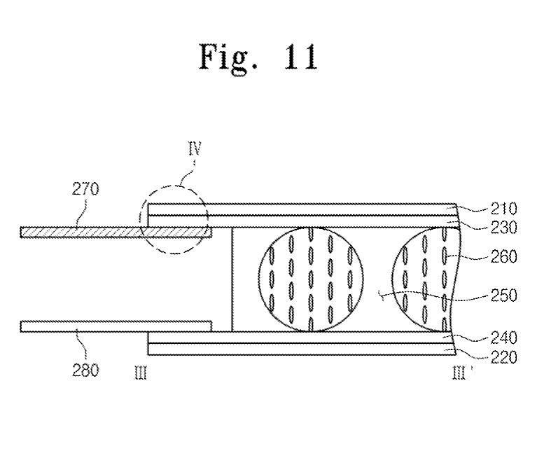

FIG. 10 is an exploded perspective view showing the EVD film of FIG. 1, in accordance with an embodiment of the present invention. FIG. 11 is a cross-sectional view taken along a line I-I′ of FIG. 11, in accordance with an embodiment of the present invention. Referring to FIGS. 10 and 11, the EVD film 200 includes the first base film 210, the second base film 220, the first transparent electrode layer 230, the second transparent electrode layer 240, and the polymer layer 250.

The first and second base films 210 and 220 are spaced apart from each other by a predetermined distance and arranged in substantially parallel to each other. The first transparent electrode layer 230 is formed on the first base film 210, and the second transparent electrode layer 240 is formed on the second base film 220 to face the first transparent electrode layer 230. The polymer layer 250 is disposed between the first and second transparent electrode layers 230 and 240, and the liquid crystal molecules 260 are distributed in the polymer layer 250.

The first base film 210 includes a first extension portion 211 outwardly extending from a side portion thereof, and the second base film 220 includes a second extension portion 221 outwardly extending from a side portion thereof. The first and second extension portions 211 and 221 are not overlapped with each other when viewed in a plan view. The first transparent layer 230 includes a first extension electrode 231 outwardly extending from a side portion thereof such that the first extension electrode 231 is positioned corresponding to the first extension portion 211, and the second transparent layer 240 includes a second extension electrode 241 outwardly extending from a side portion thereof such that the second extension electrode 241 is positioned corresponding to the second extension portion 221. The first extension electrode 231 is connected to a first flexible printed circuit (FPC) film 270, and the second extension electrode 241 is connected to a second FPC film 280.

Although not shown in figures, the first FPC film 270 includes wires to apply a first driving voltage to the first transparent layer 230, and the second FPC film 280 includes wires to apply a second driving voltage to the second transparent layer 240.

In the present exemplary embodiment, various conductive materials, such as a silver paste or an anisotropic conductive film (ACF), may be used to electrically connect the first FPC film 270 to the first extension electrode 231 of the EVD film 200. Also, the various conductive materials may be used to electrically connect the second FPC film 280 to the second extension electrode 241 of the second transparent layer 240.

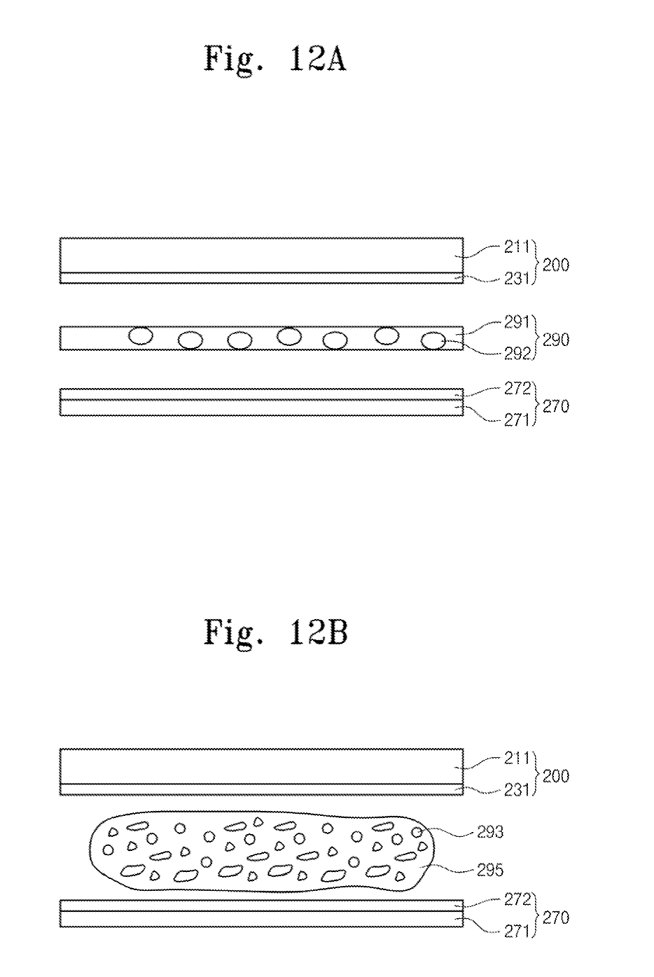

FIGS. 12A and 12B are sectional views showing a connection structure of the EVD film and an FPC film, in accordance with an embodiment of the present invention. In particular, FIG. 12A shows a connection structure of the EVD film 200 and the first FPC film 270 by using the ACF, and FIG. 12B shows a connection structure of the EVD film 200 and the first FPC film 270 by using the silver paste.

Referring to FIG. 12A, the first FPC film 270 is disposed to face the first extension electrode 231 of the EVD film 200. The first FPC film 270 includes a base film 271 and a terminal 272 disposed on the base film 271 to face the first extension electrode 231.

The ACF 290 is disposed between the first FPC film 270 and the EVD film 200. The ACF 290 includes an adhesive 291 formed in a film shape and conductive balls 292 distributed in the adhesive 291. When the first FPC film 270 and the EVD film 200 are pressurized to each other after interposing the ACF 290 between the first FPC film 270 and the EVD film 200, the first FPC film 270 and the EVD film 200 are attached to each other and the first extension electrode 231 and the terminal 272 are electrically connected to each other by the adhesive 291. After the pressurizing process, the electrical connection state between the first extension electrode 231 and the terminal 272 may be maintained by the conductive balls 292.

Referring to FIG. 12B, when the paste 295 in which conductive particles, such as silver (Ag), are dispersed is coated over the first FPC film 270 or the EVD film 200 and then the first FPC film 270 and the EVD film 200 are coupled to each other, the first extension electrode 231 and the terminal 272 are electrically connected to each other by the silver particles. As other methods of electrically connecting the first FPC film 270 and the EVD film 200, various methods, such as a soldering method using a solder paste, a taping method using a conductive carbon tape, may be used. In FIGS. 12A and 12B, the connection structure of the first FPC film 280 and the EVD film 200 has been described, however it should not be limited thereto, since the second FPC film 280 and the EVD film 200 may be coupled to each other by using the above similar methods.

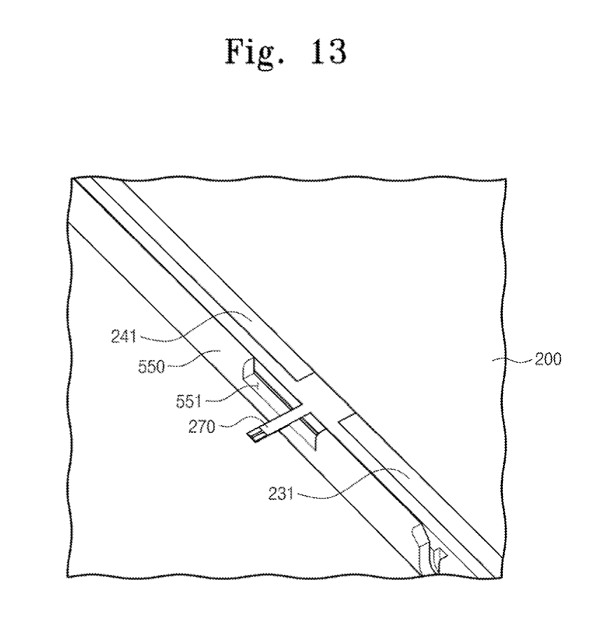

FIG. 13 is a perspective view showing a receiving container, in accordance with an embodiment of the present invention. Referring to FIG. 13, the LCD 500 includes a receiving container 550 that receives the backlight unit 100, the VAC film 300, and the EVD film 200 therein.

The receiving container 550 is provided with a guide recess 551 formed at a side wall thereof to withdraw the first and second FPC films 270 and 280 to a rear surface of the receiving container 550. In an example of the present invention, the first and second FPC films 270 and 280 may receive the first and second driving voltages from a power supply unit supplying a power source voltage to the backlight unit 100.

Since the power supply unit is disposed on the rear surface of the receiving container 550 and supplies the power source voltage to the backlight unit 100, the first and second FPC films 270 and 280 are withdrawn to the rear surface of the receiving container 550 through the guide recess 551. In the present exemplary embodiment, the receiving container 550 may be a mold frame.

In one aspect, the variable diffuser film is disposed between the backlight unit and the display panel to transmit or scatter the light in response to the electrical signals. The variable diffuser film is disposed between the two transparent electrode layers and includes the liquid crystal molecules in which the liquid crystal molecules are dispersed. Thus, the variable diffuser film may be turned on or off by the driving voltages, thereby automatically switching a viewing angle mode.

Additionally, in another aspect, since the thickness of the polymer layer is of about 3 micrometers to about 15 micrometers and the anisotropic refractive index (Δn) of the liquid crystal molecules is of about 0.15 to about 0.25, power consumption necessary to switch the viewing angle mode may be reduced, and transmittance and light scattering characteristics may be prevented from deterioration.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a backlight unit adapted to generate light;
a variable diffuser film disposed on the backlight unit and adapted to transmit or scatter the light in response to electrical signals; and
a display panel adapted to receive the light exiting from the variable diffuser film to display an image,
wherein the variable diffuser film comprises:
a first transparent electrode layer adapted to receive a first driving voltage among the electrical signals;
a second transparent electrode layer adapted to receive a second driving voltage having a voltage level different from a voltage level of the first driving voltage among the electrical signals and faces the first transparent electrode layer;
a polymer layer disposed between the first and second transparent electrode layers and including liquid crystal molecules dispersed in the polymer layer to transmit or scatter the light in response to the electrical signals,
wherein the polymer layer has a thickness of about 3 micrometers to about 15 micrometers, and
wherein the liquid crystal molecules have an anisotropic refractive index (Δn) of about 0.15 to about 0.25.

2. The display apparatus of claim 1, wherein the liquid crystal molecules have an anisotropic dielectric constant (Δε) of about 10 to about 30.

3. The display apparatus of claim 2, wherein the liquid crystal molecules are positive type liquid crystal molecules each of which having a larger dielectric constant in its long axis than a dielectric constant in its short axis.

4. The display apparatus of claim 1, wherein a concentration of the liquid crystal molecules is from about 65% to about 85%.

5. The display apparatus of claim 1, wherein the variable diffuser film further comprises a first base film and a second base film facing the first base film, and the first and second transparent electrode layers are formed on the first and second base films, respectively.

6. The display apparatus of claim 5, wherein each of the first and second transparent electrode layers comprises indium-tin-oxide (ITO).

7. The display apparatus of claim 5, wherein each of the first and second transparent electrode layers comprises a conductive polymer film.

8. The display apparatus of claim 1, wherein the polymer layer has a refractive index that is equal to an ordinary refractive index (no) or an extraordinary refractive index (ne) of the liquid crystal molecules.

9. The display apparatus of claim 1, further comprising a viewing angle control film disposed between the variable diffuser film and the backlight unit.

10. The display apparatus of claim 9, wherein the viewing angle control film comprises:
a plurality of transparent layers adapted to transmit the light exiting from the backlight unit; and
a plurality of absorbing layers adapted to absorb the light,
wherein the transparent layers are alternately arranged with the absorbing layers along a direction parallel to a horizontal surface of the backlight unit.

11. The display apparatus of claim 10, wherein each of the absorbing layers has a thickness of about 5 micrometers to about 12 micrometers.

12. The display apparatus of claim 10, wherein each of the absorbing layers comprises a carbon material and a concentration of the carbon material is from about 3% to about 12%.

13. The display apparatus of claim 10, wherein an angle (θ) between a lower surface of each of the transparent layers and an imaginary line connecting a left lower corner and a right upper corner in each of the transparent layers is from about 60 degrees to about 80 degrees.

14. The display apparatus of claim 10, wherein a sum of thicknesses of the absorbing layers and the transparent layers is about 30 micrometers to about 80 micrometers.

15. The display apparatus of claim 10, wherein the viewing angle control film further comprises:
a first protection layer covering upper surfaces of the transparent layers and the absorbing layers; and
a second protection layer covering lower surfaces of the transparent layers and the absorbing layers,
wherein each of the first and second protection layers has a thickness of about 10 micrometers to about 50 micrometers.

16. The display apparatus of claim 1, wherein the backlight unit comprises:
a light source adapted to generate the light;
a light guide plate adapted to receive the light through a side surface thereof, which is positioned adjacent to the light source, output the light through an upper surface thereof, and including a first prism pattern formed on a lower surface thereof;
a reverse prism sheet disposed on the light guide plate and including a second prism pattern formed on a lower surface thereof facing the upper surface of the light guide plate, the second prism pattern being vertical to the first prism pattern; and
a reflection sheet disposed under the light guide plate to reflect the light leaked through the lower surface of the light guide plate.

17. The display apparatus of claim 16, wherein the reflection sheet is a regular reflection sheet.

18. The display apparatus of claim 1, further comprising:
a first flexible film coupled with the first transparent electrode layer to apply the first driving voltage to the first flexible film; and
a second flexible film coupled with the second transparent electrode layer to apply the second driving voltage to the second flexible film.

19. The display apparatus of claim 18, further comprising:
a receiving container that receives the backlight unit therein,
wherein the receiving container is provided with a guide recess formed at a side wall thereof to withdraw the first and second flexible films to a rear surface of the receiving container.

20. The display apparatus of claim 18, wherein the first and second flexible films respectively receive the first and second driving voltages from a power supply unit adapted to supply a power source voltage to the backlight unit.
